(19) United States
(12) Patent Application Publication
(10) Pub. No.: US 2018/0233893 A1
(43) Pub. Date: Aug. 16, 2018

(54) Structure of Inter-Conducting Path Connecting Portion and Wire Harness

(71) Applicant: Yazaki Corporation, Tokyo (JP)

(72) Inventors: Hideomi Adachi, Makinohara-shi (JP); Takeshi Ogue, Makinohara-shi (JP); Masahide Tsuru, Makinohara-shi (JP); Hiroyuki Yoshida, Makinohara-shi (JP); Toshihiro Nagashima, Makinohara-shi (JP); Tetsuo Yamada, Makinohara-shi (JP)

(73) Assignee: Yazaki Corporation, Tokyo (JP)

(21) Appl. No.: 15/868,631

(22) Filed: Jan. 11, 2018

(30) Foreign Application Priority Data
Feb. 13, 2017 (JP) 2017-023846

(51) Int. Cl. H02G 15/18; H01R 4/60; H01R 4/62; H01R 4/70; H01B 7/00; H01B 7/18; H01B 7/282; B60R 16/02

(52) U.S. Cl. CPC H02G 15/18; H01R 4/60; H01R 4/62; B60R 16/0215; H01B 7/0045; H01B 7/18; H01B 7/282; H01R 4/70

(57) ABSTRACT

A structure of an inter-conducting path connecting portion which is a connecting site of one and the other cut conducting paths which are in a cut state and in an adjacent state is provided. The structure includes an inter-connecting end connecting portion in which connecting ends of conductors of the one and the other cut conducting paths are connected to each other, a conductor exposed portion in which outer circumferences of the conductors are exposed on both sides of the inter-connecting end connecting portion, an insulating waterproof treatment portion for performing treatment directly on the conductor exposed portion such that the conductor exposed portion comes into an insulating state and a waterproof state, and a shield processing part that covers the entire insulating waterproof treatment portion.

### CROSS REFERENCE TO RELATED APPLICATIONS

This application is based on Japanese Patent Application (No. 2017-023846) filed on Feb. 13, 2017, the contents of which are incorporated herein by reference.

### BACKGROUND

The present invention relates to a structure of a connecting site between conducting paths. In addition, the present invention relates to a wire harness that is routed in a car so as to perform electrical connection.

As an example of a high-voltage wire harness, Patent Document 1 discloses a wire harness for electrically connecting high-voltage devices which are mounted on a hybrid car or an electric car. The wire harness is configured to include three flexible high-voltage wires (conducting paths) and three exterior members that accommodate and protect the three high-voltage wires one by one. The exterior member is a metal pipe having a circular cross section. After a high-voltage wire is inserted into such an exterior member, a connector or the like is attached to a terminal of the high-voltage wire, and then manufacturing of a wire harness is completed. In the manufacturing of the wire harness, bending of the exterior member (metal pipe) is performed to match a shape of a routing target position of the wire harness.

[Patent Document 1]: JP 2004-224156 A

### SUMMARY

An object of the present invention is to provide a structure that makes it possible to secure insulation properties, waterproof properties, and shielding properties in a connecting site between conducting paths and a wire harness that employs the structure.

The present invention according to a first aspect made in order to achieve the object described above provides a structure of an inter-conducting path connecting portion which is a connecting site of one and the other cut conducting paths which are in a cut state and in an adjacent state, the structure including:

an inter-connecting end connecting portion in which connecting ends of conductors of the one and the other cut conducting paths are connected to each other;

a conductor exposed portion in which outer circumferences of the conductors are exposed on both sides of the inter-connecting end connecting portion;

an insulating waterproof treatment portion for performing treatment directly on the conductor exposed portion such that the conductor exposed portion comes into an insulating state and a waterproof state; and

a shield processing part that covers the entire insulating waterproof treatment portion.

The present invention according to a second aspect provides the structure of an inter-conducting path connecting portion according to the first aspect further including:

a shield connecting part for connecting end portions of shielding members that configure the one and the other cut conducting paths and end portions of the shield processing part to each other.

The present invention according to a third aspect provides the structure of an inter-conducting path connecting portion according to the first or second aspect, wherein the one cut conducting path has a stiffness so as to ensure shape retention performance, and the other cut conducting path has lower shape retention performance than that of the one cut conducting path and has flexibility.

In addition, the present invention according to a fourth aspect made in order to achieve the object described above provides a wire harness configured to be routed in a car so as to perform electrical connection, the wire harness includes one or a plurality of conducting paths, in which one of the conducting path includes a plurality of cut conducting paths which are in a cut state and an inter-conducting path connecting portion that is a connecting site of the one and the other cut conducting paths adjacent to each other and has the structure according to the first, second, or third aspect.

### BRIEF DESCRIPTION OF DRAWINGS

FIGS. 1A and 1B illustrate views of a wire harness of the present invention, FIG. 1A is a schematic view illustrating a routing state of a high-voltage wire harness, and FIG. 1B is a schematic view illustrating a routing state of a low-voltage wire harness different from FIG. 1A.

FIG. 2 is a view of an entire configuration of one of conducting paths that configure the wire harness in FIGS. 1A and 1B.

FIG. 3 is an enlarged view of main parts of FIG. 2 and a view of a configuration of an inter-conducting path connecting portion of the present invention.

FIGS. 4A to 4C illustrate cross-sectional views of FIG. 3, FIG. 4A is a cross-sectional view taken along line A-A, FIG. 4B is a cross-sectional view taken along line B-B, and FIG. 4C is a cross-sectional view taken along line C-C.

FIGS. 5A to 5C illustrate cross-sectional views of FIG. 3, FIG. 5A is a cross-sectional view taken along line D-D, FIG. 5B is a cross-sectional view taken along line E-E, and FIG. 5C is a cross-sectional view taken along line F-F.

FIG. 6 is a view illustrating a first process according to forming of the inter-conducting path connecting portion.

FIG. 7 is a view illustrating a second process according to forming of the inter-conducting path connecting portion.

FIG. 8 is a view illustrating a third process according to forming of the inter-conducting path connecting portion.

FIG. 9 is a view illustrating a modification example of the third process in FIG. 8.

FIG. 10 is a view illustrating a modification example of the first to third processes in FIGS. 6 to 8.

FIGS. 11A to 11C illustrate views of an application example of the inter-conducting path connecting portion, FIG. 11A is a schematic view when one conducting path is in a state of matching a routing path, FIG. 11B is a schematic view when the conducting path is applied as dimension error absorbing means, and FIG. 11C is a schematic view when the conducting path is applied as resonance avoiding means.

FIGS. 12A and 12B illustrate views of another application example of the inter-conducting path connecting portion, and FIGS. 12A and 12B are schematic views.

FIG. 13 is a configurational view illustrating an inter-conducting path connecting portion as another example.

FIG. 14 is a cross-sectional view of the conducting path in FIG. 13.

### DETAILED DESCRIPTION OF EXEMPLIFIED EMBODIMENTS

In the related art, since the wire harness has a configuration in which the flexible high-voltage wire (conducting path) is used, it is necessary to perform routing after shape retention in the metal pipe in order to perform the routing of the wire harness by matching the shape of the routing target position (a shape of a routing path) with good workability. In other words, in the related art, the metal pipe as the exterior member is a constituent member required for improvement in workability.

The inventors of the present application studied whether it is not possible to exhibit a shape retention function of matching a shape of a routing target position without using the metal pipe. As a result, the inventors reached an idea that a conducting path having a shape retention function and a flexible conducting path without having such a function are connected (joined) so as to form one conducting path.

However, according to the idea, since it is necessary that the conducting paths having different functions are connected (joined) to each other so as to form one conducting path, an insulator or the like is removed from a connecting site and a conductor is exposed. Therefore, a problem arises in that insulation properties or waterproof properties needs to be secured, or a problem arises in that shielding properties also needs to be secured.

The present invention is made in consideration of the circumstance described above, and an object thereof is to provide a structure that makes it possible to secure insulation properties, waterproof properties, and shielding properties in a connecting site between conducting paths and a wire harness that employs the structure.

A wire harness is configured to include one or a plurality of conducting paths. A single conducting path is configured to include a plurality of cut conducting paths which are in a cut state and an inter-conducting path connecting portion that is a connecting site of one and the other cut conducting paths adjacent to each other. The inter-conducting path connecting portion is configured to include an inter-connecting end connecting portion, a conductor exposed portion, an insulating waterproof treatment portion, and a shield processing part. The inter-connecting end connecting portion is formed when connecting ends of the conductors of the one and the other cut conducting paths are connected to each other. The insulating waterproof treatment portion is provided to perform treatment directly on the conductor exposed portion, which is exposed as an outer circumference of each of the conductor on both sides of the inter-connecting end connecting portion such that the conductor exposed portion comes into an insulating state and a waterproof state. The shield processing part is provided to cover the entire insulating waterproof treatment portion.

### EXAMPLE 1

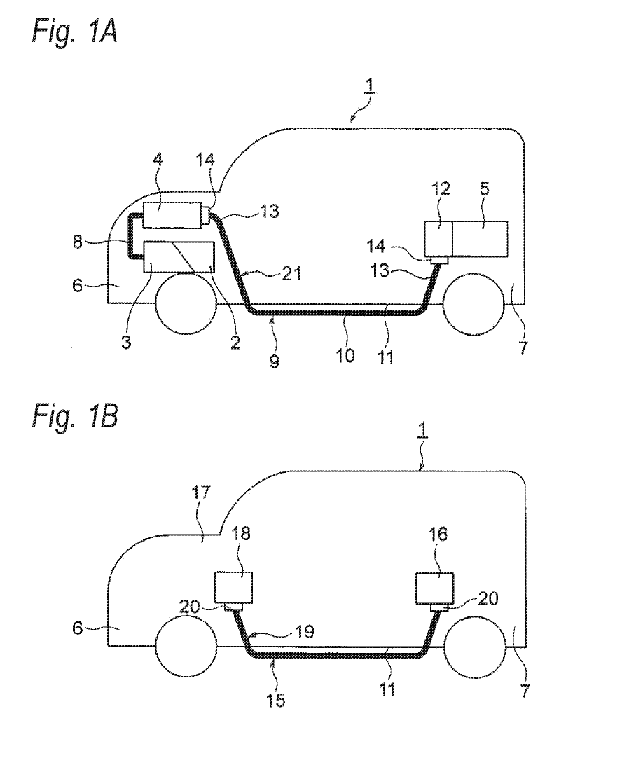

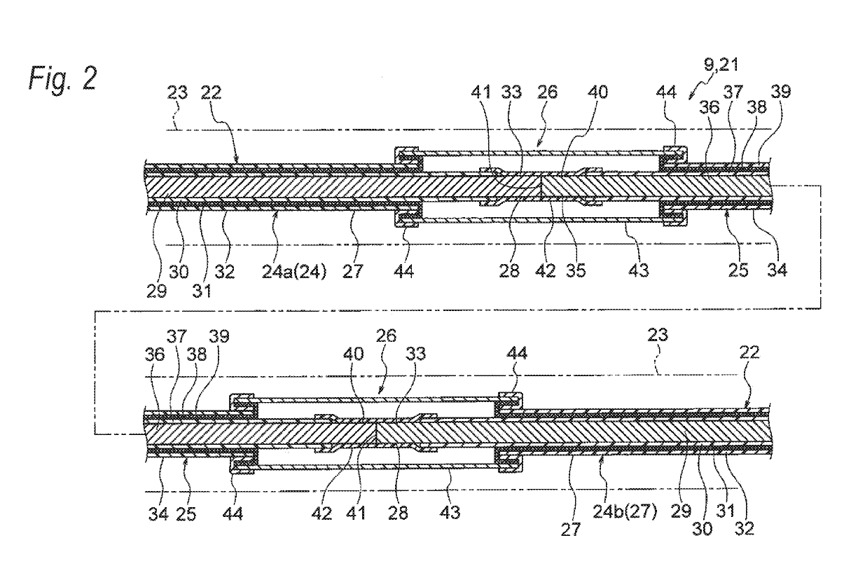

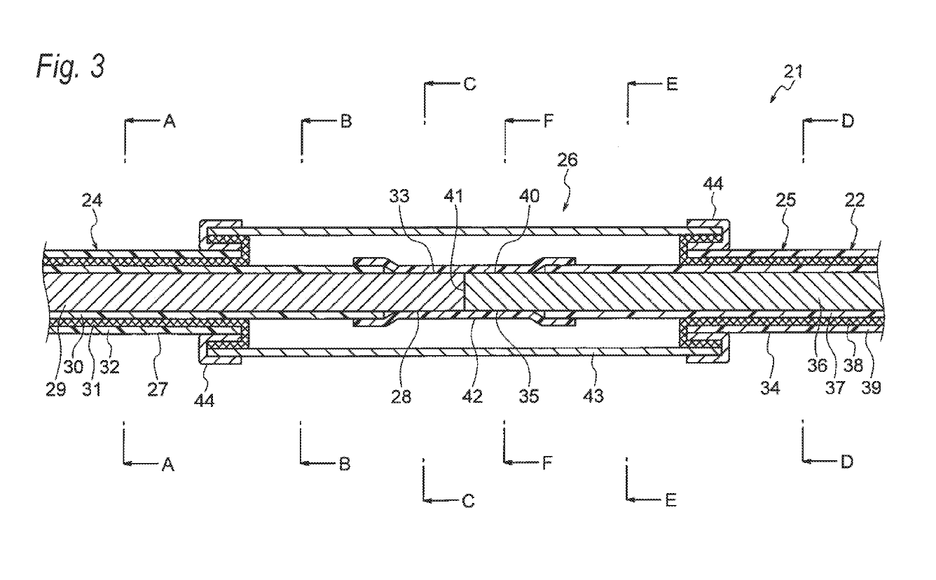

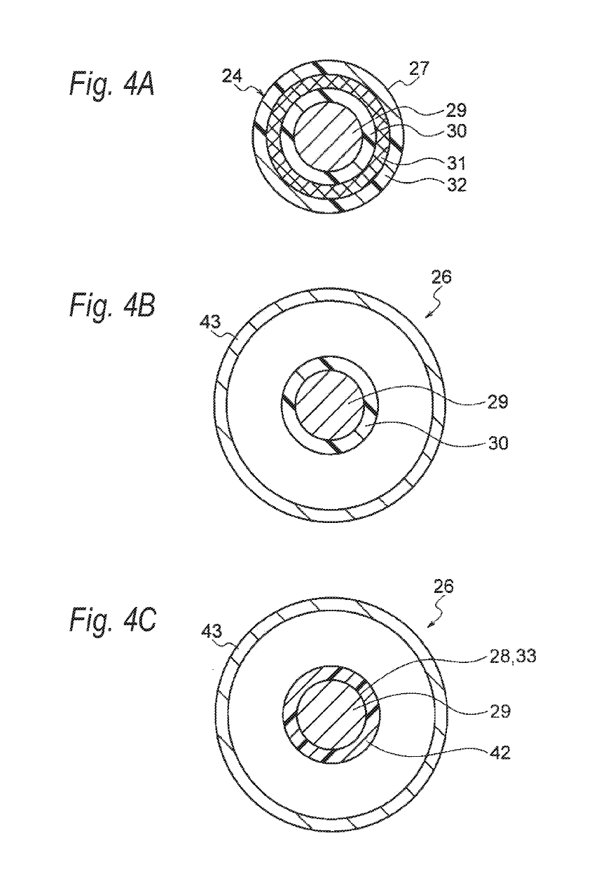

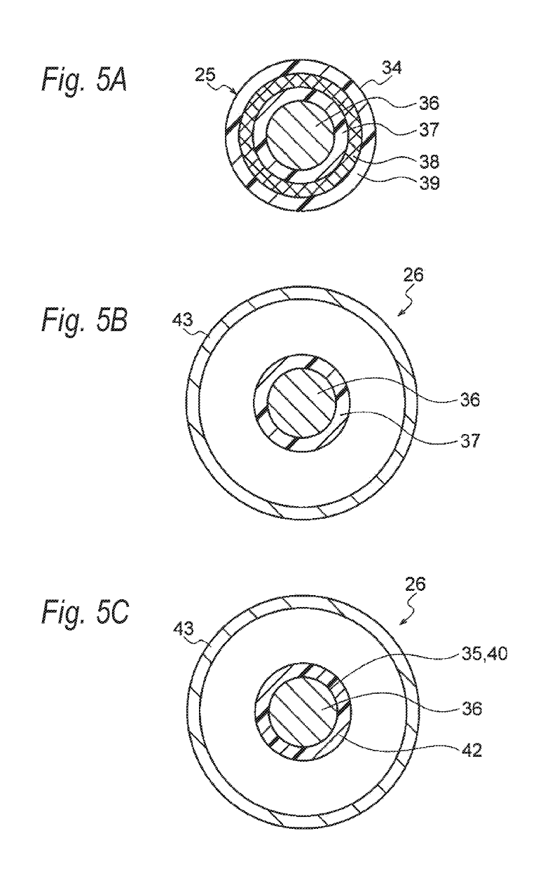

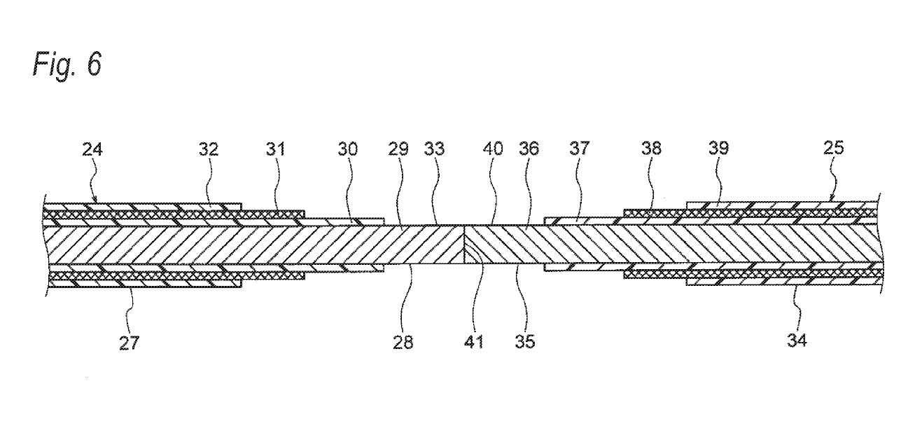

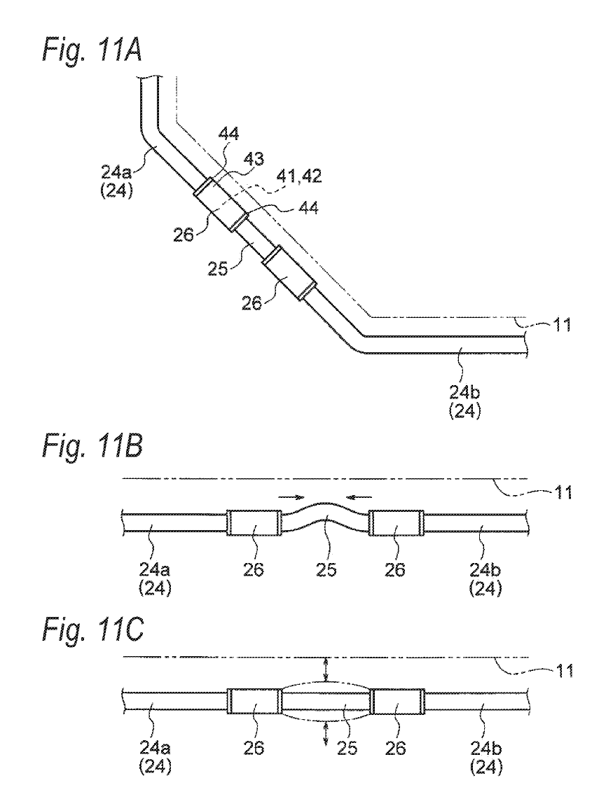

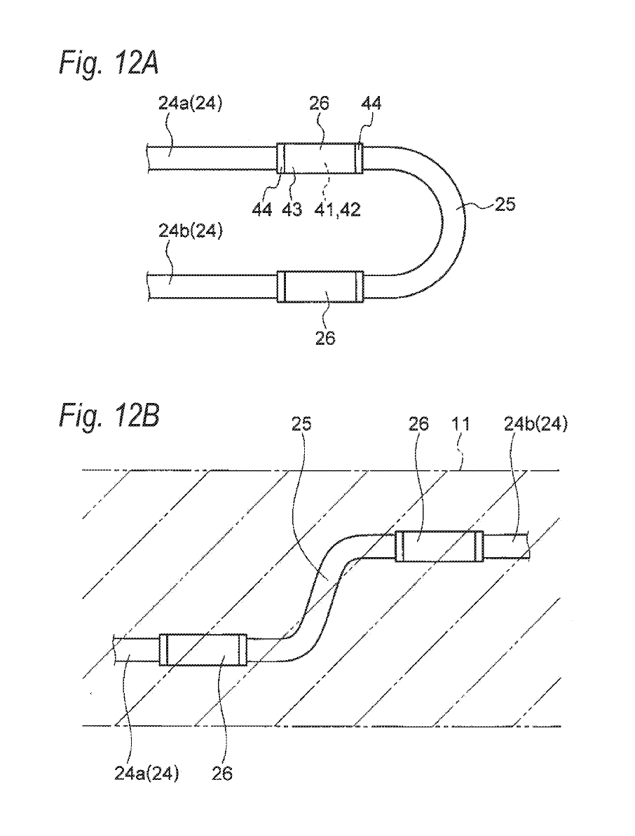

Hereinafter, Example 1 will be described with reference to figures. FIGS. 1A and 1B illustrate views of a wire harness of the present invention, FIG. 1A is a schematic view illustrating a routing state of a high-voltage wire harness, and FIG. 1B is a schematic view illustrating a routing state of a low-voltage wire harness different from FIG. 1A. In addition, FIG. 2 is a view of an entire configuration of one of conducting paths that configure the wire harness in FIGS. 1A and 1B. FIG. 3 is an enlarged view of main parts of FIG. 2. FIGS. 4 and 5 are cross-sectional views of FIG. 3. In addition, FIGS. 6 to 10 are views illustrating processes according to forming of the inter-conducting path connecting portion. FIGS. 11A to 12B are views illustrating application examples of the inter-conducting path connecting portion.

According to the example, the present invention is employed to a wire harness that is routed in a hybrid car (car that may be an electric car, a general car which runs by an engine, or the like).

### <Regarding Structure of Hybrid Car 1>

In FIG. 1A, reference numeral 1 represents a hybrid car. The hybrid car 1 is a vehicle that is driven with a mix of two types of power from an engine 2 and a motor unit 3, and the power is supplied from a battery 5 (battery pack) via an inverter unit 4 to the motor unit 3. The engine 2, the motor unit 3, and the inverter unit 4 are mounted on an engine room 6 at a position of a front wheel or the like in the example. In addition, the battery 5 is mounted on a rear region 7 of the car in which a rear wheel or the like is present (is mounted in the interior of the car on the rear side from the engine room 6).

The motor unit 3 and the inverter unit 4 are connected by a high-voltage wire harness 8 (motor cable for high voltage). In addition, the battery 5 and the inverter unit 4 are also connected by a high-voltage wire harness 9. The wire harness 9 has an intermediate portion 10 that is routed on a vehicle underside 11 in a vehicle (in a vehicle body). In addition, the intermediate portion 10 is routed substantially in parallel along the vehicle underside 11. The vehicle underside 11 is a known body (vehicle body) and a so-called panel member, and is provided with a through-hole formed at a predetermined position. The wire harness 9 is inserted into the through-hole in a water-tight manner.

The wire harness 9 and the battery 5 are connected via a junction block 12 that is provided in the battery 5. External connecting means such as a shield connector 14 disposed at a harness terminal 13 on the rear end side of the wire harness 9 is electrically connected to the junction block 12. In addition, the wire harness 9 and the inverter unit 4 are electrically connected via the external connecting means such as the shield connector 14 disposed at the harness terminal 13 on the front end side thereof.

The motor unit 3 is configured to include a motor and a generator. In addition, the inverter unit 4 is configured to include an inverter and a converter. The motor unit 3 is formed as a motor assembly including a shield case. In addition, the inverter unit 4 is also formed as an inverter assembly including a shield case. The battery 5 is a Ni-MH type or Li-ion type battery and is formed to be modularized. For example, it is also possible to use an electricity storage device such as a capacitor. It is needless to say that the battery 5 is not particularly limited thereto as long as the battery 5 can be used in the hybrid car 1 or the electric car.

In FIG. 1B, reference numeral 15 represents a wire harness. A wire harness 15 is a low-voltage wire harness (for a low voltage) and is provided to electrically connect both of a low-voltage battery 16 of the rear region 7 of the car and accessories 18 (devices) which are mounted in a front region 17 of the car in the hybrid car 1. Similar to the wire harness 9 in FIG. 1A, the wire harness 15 is routed through the vehicle underside 11 (as an example, and may be routed through a side of the vehicle interior). Reference numeral 19 in the wire harness 15 represents a harness main body. In addition, reference numeral 20 represents a connector.

As illustrated in FIGS. 1A and 1B, the high-voltage wire harnesses 8 and 9 and the low-voltage wire harness 15 are routed in the hybrid car 1. The present invention is applicable to any one of the wire harnesses; however, the high-voltage wire harness 9 will be described below as a representative example. First, a configuration and a structure of the wire harness 9 are described.

### <Regarding Structure of Wire Harness 9>

In FIG. 1A, the elongated wire harness 9, which is routed through the vehicle underside 11, is configured to include the harness main body 21 and the shield connectors 14 (external connecting means) which are disposed at both terminals (harness terminals 13) of the harness main body 21. In addition, the wire harness 9 is configured to include a clamp (not illustrated) for routing the wire harness at a predetermined position and a waterproof member (for example, a grommet) (not illustrated).

### <Regarding Structure of Harness Main Body 21>

In FIGS. 1A and 2, the harness main body 21 is configured to include one or a plurality of conducting paths 22 (refer to FIG. 2) and an exterior member 23 for accommodating and protecting the one or plurality of conducting paths 22. Regarding the number of conducting paths, two conducting paths 22 are provided in the example; however, this is an example. In addition, in the example, only one of the two conducting paths (only one conducting path 22) is described.

There is no particular limitation to exterior member 23, and the exterior member is formed by employing a common corrugated tube that is made of resin and has flexibility. Here, detailed description thereof is omitted.

First, a configuration and a structure of one conducting path 22 in the harness main body 21 is described with reference to the figures.

In FIG. 2, the one conducting path 22 is configured as follows. In other words, when viewed in the figures of the example, the one conducting path 22 is configured to include first cut conducting paths 24 (24a, 24b, . . . ) in a state of being cut into a plurality of paths, a second cut conducting path 25 connecting the adjacent first cut conducting paths 24 (24a and 24b to each other), an inter-conducting path connecting portion 26 of the present invention which is formed as a direct connecting site between the first cut conducting paths 24 and the second cut conducting path 25, and terminal metal fittings (not illustrating) provided at terminals of the one conducting path 22. The one conducting path 22 is an elongated one although not clearly shown in FIG. 2.

### <Regarding One of Plurality of Conducting Paths 22>

In FIG. 2, in the example, the one conducting path 22 has the four or more first cut conducting paths 24 and the number of the second cut conducting paths 25 (illustrated a part thereof in the example since the path is elongated) which is a number obtained by subtracting 1 from the number of the first cut conducting paths 24. The one conducting path 22 of the example is not used in a configuration in which a single conducting path is used, but is used in a configuration in which multiple conducting paths are used. In addition, the one conducting path 22 is not a conducting path having three divided configurations of a first conducting path as a main portion and two conducting paths that are connected to both ends of the first conducting path. Further, as will be clearly understood in the following description, the one conducting path 22 is not a conducting path in which at least one second cut conducting path 25 is disposed in a routing range along the vehicle underside 11 (refer to FIGS. 1A and 1B), that is, a conducting path having a single configuration in the range.

### <Regarding First Cut Conducting Path 24>

In FIGS. 2 to 4C, the first cut conducting path 24 is provided as a site that occupies the majority of the one conducting path 22. The first cut conducting path 24 is configured to include a main body portion 27 and connecting ends 28 positioned at both ends of the main body portion 27. The main body portion 27 is configured to include a conductive rod conductor 29, an insulator 30 having insulation properties with which the rod conductor 29 is coated, a conductive shielding member 31 that is provided on an outer side of the insulator 30, and a sheath 32 having the insulation properties with which the shielding member 31 is coated.

The connecting ends 28 are formed as connecting sites of the second cut conducting path 25. In the example, the connecting end 28 is formed by removing the insulator 30 and the sheath 32 from the terminal of the main body portion 27 and exposing the rod conductor 29. Reference numeral 33 represents a conductor exposed portion that is exposed as an outer circumference of the rod conductor 29 (connecting end 28).

The first cut conducting paths 24 (main body portion 27) are formed to have a length required for retaining a shape along a routing path. In other words, the first cut conducting paths 24 (24a, 24b, . . . ) are each formed to have an appropriate length. In the example, some of the first cut conducting paths 24 are formed to have a length so as to be routed along the vehicle underside 11 (refer to FIGS. 1A and 1B). Some first cut conducting paths 24 routed on the vehicle underside 11 are formed in a state in which the first cut conducting paths 24 are relatively longer than other first cut conducting paths 24 on another site.

The rod conductor 29 is manufactured by using copper or a copper alloy, or aluminum or an aluminum alloy. The example employs an aluminum rod conductor having merits of low costs and light weight (as an example). The rod conductor 29 is formed as a round wire having a circular cross section (or is formed as a rectangular wire having a rectangular cross section). In addition, the rod conductor 29 is formed to have a straight shape. The round wire (or the rectangular wire) is also called a single core round wire (or a single core rectangular wire). The rod conductor 29 is formed to have the stiffness to the extent that it is possible to retain the shape along the routing path. The stiffness of the rod conductor 29 is the stiffness with which plastic deformation is maintained even when an external force is applied to some extent. Therefore, the rod conductor is hard, compared to a conductor 36 of the second cut conducting path 25, which will be described below.

As the rod conductor 29, a bus bar or the like may be employed other than the wires described above. In other words, there is no particular limitation to the rod conductor, as long as the rod conductor has the stiffness to the extent that it is possible to retain the shape. For example, a hard stranded conductor may be employed.

The insulator 30 is formed as a coating cover having a circular cross section through extrusion molding on an outer circumferential surface of the rod conductor 29 using a thermoplastic resin material. The insulator 30 is formed to have a predetermined thickness. As the above-described thermoplastic resin, it is possible to use various types of known resins. For example, the resin is appropriately selected from polymer materials such as polyvinyl chloride resin, polyethylene resin, and polypropylene resin.

As the shielding member 31, a tubular braid obtained by knitting fine wires having conductivity is employed (the material is not limited to the braid, and metal foil or the like may be used as the shielding member 31). The shielding member 31 is formed to have a shape and a size so as to cover the entire outer circumferential surface from one end to the other end of the insulator 30 (first cut conducting path 24). The shielding member 31 is provided to perform shield processing on the first cut conducting path 24.

The sheath 32 is formed as a coating cover having a circular cross section through extrusion molding on an outer side of the shielding member 31 using a thermoplastic resin material. The sheath 32 is formed to have a predetermined thickness. As the above-described thermoplastic resin, it is possible to use various types of known resins. Similar to the insulator 30, for example, the resin is appropriately selected from polymer materials such as polyvinyl chloride resin, polyethylene resin, and polypropylene resin.

<Regarding Second Cut conducting Path 25>

In FIGS. 2, 3, and 5, the second cut conducting path 25 are configured to include a main body portion 34 and connecting ends 35 positioned at both ends of the main body portion 34. The second cut conducting path 25 has a lower stiffness than that of the first cut conducting path 24, and a material that is shrinkable and bendable in a predetermined direction is employed in the example.

The main body portion 34 is configured to include a flexible conductor 36 having conductivity, an insulator 37 having insulation properties with which the conductor 36 is coated, a conductive shielding member 38 that is provided on an outer side of the insulator 37, and a sheath 39 having the insulation properties with which the shielding member 38 is coated. The second cut conducting path 25 is formed to have a length required for exhibiting the following function. In addition, in order to exhibit the function, the second cut conducting path 25 is disposed at a required position. The second cut conducting path 25 (main body portion 34) is formed to be shorter than the first cut conducting path 24. In addition, the second cut conducting path 25 is formed to have a length such that an occupying percentage thereof in the conducting path 22 is reduced.

The connecting ends 35 are formed as connecting sites of the first cut conducting path 24. In the example, the connecting end 35 is formed by removing the insulator 37 and the sheath 39 from the terminal of the main body portion 34 and exposing the conductor 36. Reference numeral 40 represents a conductor exposed portion that is exposed as an outer circumference of the conductor 36 (connecting end 35).

The second cut conducting path 25 is formed to be bendable in two directions or in a 360-degree direction. Specifically, the second cut conducting path 25 is formed to be bendable in an upward direction and a downward direction, bendable in a leftward direction and a rightward direction, or further bendable in the 360-degree direction. The second cut conducting path 25 is formed to be bendable in various ways. The second cut conducting path 25 is also used as means for exhibiting the following function. Specifically, the second cut conducting path 25 may be used as folding means, dimension error absorbing means, resonance avoiding means, or vibration absorbing means, in addition to the bending means.

In a case where the second cut conducting path 25 is used as the bending means, the function of making it possible to bend (to bend in which it is also easy to perform bending back) in the two directions or in the 360-degree direction is exhibited. In addition, in a case where the second cut conducting path 25 is used as the folding means, a function of making it possible to achieve compactness during packaging or transporting before the routing in the hybrid car 1 is exhibited. In addition, in a case where the second cut conducting path 25 is used as the dimension error absorbing means, a function of making it possible to absorb a dimension error during the routing is exhibited. In addition, in a case where the second cut conducting path 25 is used as the resonance avoiding means, a function of making it possible to avoid the resonance after the routing is exhibited. In addition, in a case where the second cut conducting path 25 is used as the vibration absorbing means, a function of making it possible to absorb the vibration after the routing is exhibited.

The conductor 36 is manufactured by using copper or a copper alloy, or aluminum or an aluminum alloy. The example employs an aluminum rod conductor having merits of low costs and light weight (as an example). The conductor 36 is formed to have a circular cross section which is similar to the rod conductor 29 of the first cut conducting path 24 or obtained by twisting a plurality of wires. In a case of the former, the conductor is formed to have the same size (diameter) as that of the rod conductor 29. In a case of the latter, the diameter, the number, or the like of the wires is set such that a cross-sectional area of the conductor 36 matches a cross-sectional area of the rod conductor 29 of the first cut conducting path 24. The conductor 36 is formed to have flexibility with the lower stiffness than that of the rod conductor 29.

The insulator 37 is formed as a coating cover having a circular cross section through extrusion molding on an outer circumferential surface of the conductor 36 using a thermoplastic resin material. The insulator 37 is formed to have a predetermined thickness. As the above-described thermoplastic resin, it is possible to use various types of known resins. For example, the resin is appropriately selected from polymer materials such as polyvinyl chloride resin, polyethylene resin, and polypropylene resin.

As the shielding member 38, a tubular braid obtained by knitting fine wires having conductivity is employed (the material is not limited to the braid, and metal foil or the like may be used as the shielding member 38). The shielding member 38 is formed to have a shape and a size so as to cover the entire outer circumferential surface from one end to the other end of the insulator 37 (second cut conducting path 25). The shielding member 38 is provided to perform shield processing on the second cut conducting path 25.

The sheath 39 is formed as a coating cover having a circular cross section through extrusion molding on an outer side of the shielding member 38 using a thermoplastic resin material. The sheath 39 is formed to have a predetermined thickness. As the above-described thermoplastic resin, it is possible to use various types of known resins. Similar to the insulator 37, for example, the resin is appropriately selected from polymer materials such as polyvinyl chloride resin, polyethylene resin, and polypropylene resin.

### <Regarding Inter-Conducting Path Connecting Portion 26 of Present Invention>

In FIGS. 2 to 5, as described above, the inter-conducting path connecting portion 26 is formed as a direct connecting site between the first cut conducting path 24 and the second cut conducting path 25. Specifically, the inter-conducting path connecting portion 26 is formed as the connecting site in which an inter-connecting end connecting portion 41 between the first cut conducting path 24 and the second cut conducting path 25 is formed. In addition, the inter-conducting path connecting portion 26 is also formed as a site in which the insulation properties, the waterproof properties, and the shielding properties are secured in the direct connecting site. The inter-conducting path connecting portion 26 is configured to include the inter-connecting end connecting portion 41, the conductor exposed portions 33 and 40 of the first cut conducting path 24 and the second cut conducting path 25, an insulating waterproof treatment portion 42, a shield processing part 43, and two shield connecting parts 44. Hereinafter, first, a configuration and a structure thereof are more specifically described.

### <Regarding Inter-Connecting End Connecting Portion 41>

In FIG. 3, the inter-connecting end connecting portion 41 is formed in connection by appropriate means in a state in which an end surface of the connecting end 28 of the one first cut conducting path 24 matches an end surface of the connecting end 35 of the other second cut conducting path 25. The inter-connecting end connecting portion 41 may be formed in a state of maintaining electrical connection.

### <Regarding Insulating Waterproof Treatment Portion 42>

In FIG. 3, the conductor exposed portions 33 and 40 of the first cut conducting path 24 and the second cut conducting path 25 are directly subjected to treatment so as to enter an insulation state and a waterproof state as illustrated in the figures, and thereby the insulating waterproof treatment portion 42 is formed. The insulating waterproof treatment portion 42 is formed to be in a straddling state over end portions of the insulators 30 and 37 of the first cut conducting path 24 and the second cut conducting path 25. In addition, a state in which infiltration of moisture or the like from outside does not occur all over the circumference thereof is achieved. In addition, a state in which the conductor exposed portions 33 and 40 are not exposed all over the circumference thereof is achieved. In order to achieve such states, any one type of treatment of resin molding, silicon potting, heat shrinkable tubing, collective sheathing is performed on the insulating waterproof treatment portion 42.

### <Regarding Shield Processing Part 43>

In FIG. 3, the shield processing part 43 is provided to perform the shield processing of covering the entire outer side of the insulating waterproof treatment portion 42. The shield processing part 43 is formed to be longer than the insulating waterproof treatment portion 42. In addition, the shield processing part 43 is the same as the shielding members 31 and 38 of the first cut conducting path 24 and the second cut conducting path 25, respectively, and is formed to have a tubular shape. Here, the shield processing part 43 is formed to have the tubular shape with a braid. Depending on the shield connecting parts 44 which will be described below, it is possible to form the shield processing part 43 by employing metal foil, a metal pipe, or the like, other than the braid.

### <Regarding Two Shield Connecting Parts 44>

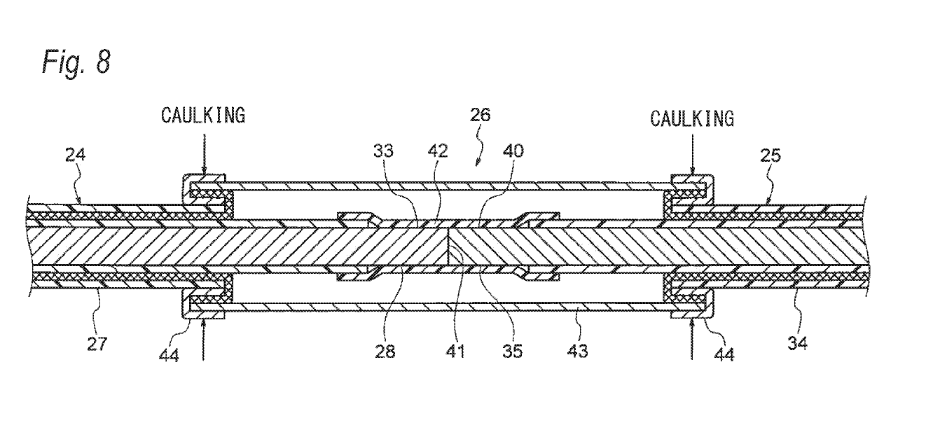

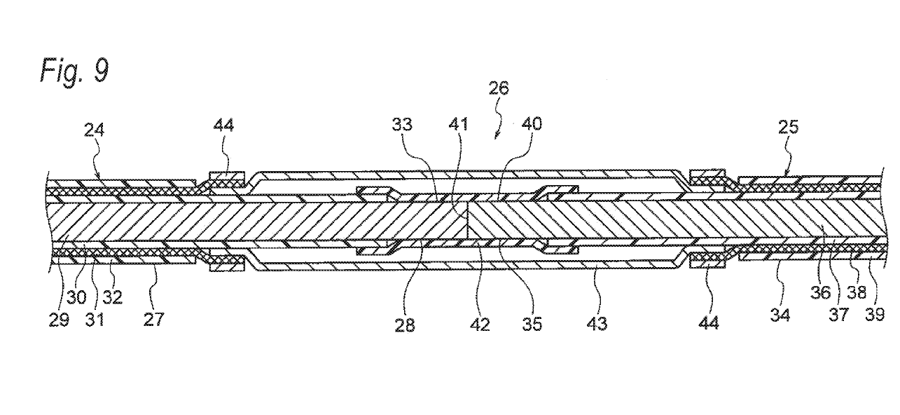

In FIG. 3, the two shield connecting parts 44 are provided to connect the shield processing parts 43 and the shielding members 31 and 38 of the first cut conducting path 24 and the second cut conducting path 25. The two shield connecting parts 44 are both formed annularly to have the same sectional shape. Specifically, in a case of the shapes illustrated in FIGS. 3 and 8, the shield connecting part is formed annularly to have a U-shaped section. In addition, the shield connecting parts are formed such that folded end portions of the shielding members 31 and 38 and the end portions of the shield processing part 43 are inserted into the U-shaped site, and then it is possible to perform pressure bonding with caulking from the outside. In a case of the shape illustrated in FIG. 9, a band plate is formed to have an annular shape. In addition, the shield connecting parts are formed such that the end portions of the shielding members 31 and 38 and the end portions of the shield processing part 43 overlap each other, the shield connecting parts are disposed on the outer side of the end portions, and then it is possible to perform pressure bonding with caulking. Otherwise, a band may be employed as long as it is possible to perform the pressure bonding or the like.

The two shield connecting parts 44 are used, and thereby it is needless to say that it is possible to connect the end portions of the shielding members 31 and 38 to the shield processing parts 43 without performing specific processing on the end portions of the shielding members in the first cut conducting path 24 and the second cut conducting path 25.

### <Regarding Forming of Inter-Conducting Path Connecting Portion 26>

Hereinafter, processes through which the inter-conducting path connecting portion 26 is formed will be described with reference to the figures. The processes include first to third processes.

In FIG. 6, in the first process, the connection is performed by the appropriate means in a state in which the end surface of the connecting end 28 of the first cut conducting path 24 matches the end surface of the connecting end 35 of the other second cut conducting path 25. In the first process, the inter-connecting end connecting portion 41 is formed. The end surfaces are connected to each other by forming the inter-connecting end connecting portion 41, and thus the electrical connection is performed.

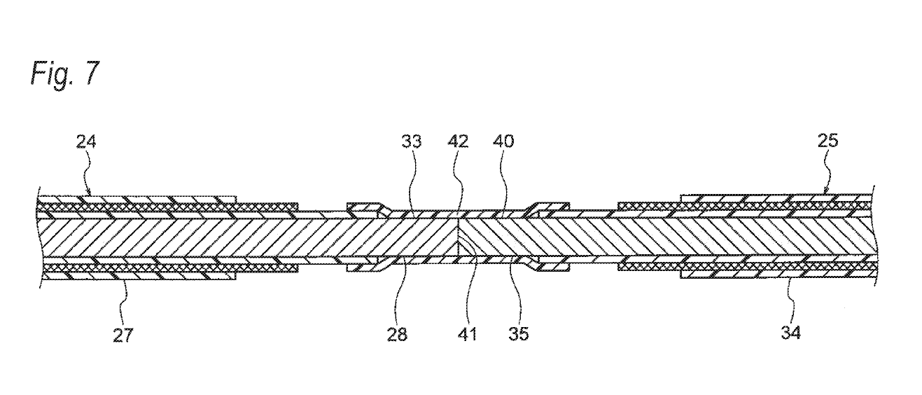

In FIG. 7, in the second process, the conductor exposed portions 33 and 40 of the first cut conducting path 24 and the second cut conducting path 25 are directly subjected to the treatment so as to enter the insulation state and the waterproof state. In the second process, the insulating waterproof treatment portion 42 is formed. An exposed site or a gap site is not provided by forming the insulating waterproof treatment portion 42, and thus the high-voltage connecting site comes into the insulation state and the waterproof state such that stability, reliability, or the like is ensured.

In FIG. 8 (or FIG. 9), in the third process, by using the two shield connecting parts 44, the shield processing parts 43 and the shielding members 31 and 38 of the first cut conducting path 24 and the second cut conducting path 25 are connected with the caulking. A connection completed state is as illustrated in FIG. 3. In the third process, the site is formed to perform the shield processing of covering the entire outer side of the insulating waterproof treatment portion 42.

### <Regarding Modification Example>

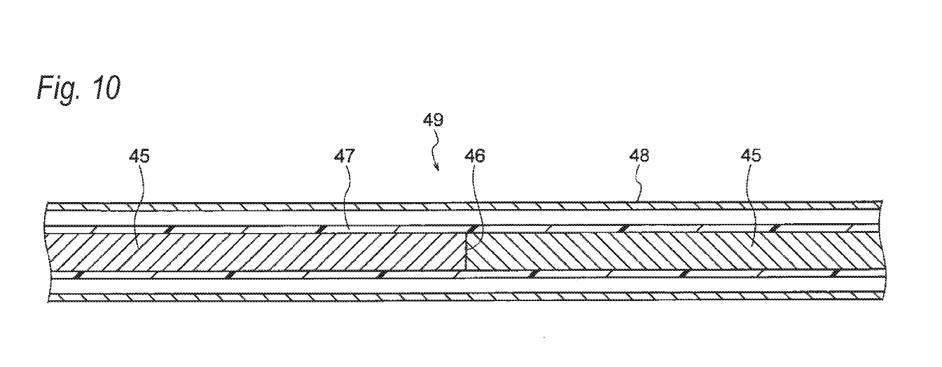

As illustrated in FIG. 10, in a case where only wire conductors 45 are connected to each other, first, an inter-connecting end connecting portion 46 is formed, then, collective sheathing 47 is placed and, finally, the entire portion is covered with a shield processing part 48 formed of a braid. It is possible to form an inter-conducting path connecting portion 49.

### <Regarding Application Example of Inter-Conducting Path Connecting Portion 26>

A shape of a routing path formed by the one conducting path 22 is described on the basis of the configuration and the structure. In the description of the shape of the routing path, an illustration of the exterior member 23 is omitted for convenience.

Here, in FIG. 11A, a first cut conducting path 24a, a first elongated cut conducting path 24b, the second cut conducting paths 25 connecting the two cut conducting paths, and the two inter-conducting path connecting portions 26 are illustrated. An intermediate portion of the first cut conducting path 24a is bent, and the bending shape is retained. The rod conductor 29 that configures the first cut conducting path 24a is plastically deformed, and thereby a predetermined bending shape is retained. One end side of the first elongated cut conducting path 24b is bent, and the bending shape is retained. As described above, for the bending on the one side, the rod conductor 29 is plastically deformed, and thereby a predetermined bending shape is retained. An intermediate portion of the first elongated cut conducting path 24b is routed along the vehicle underside 11. The second cut conducting path 25 is used as bending means for making it easy to handle a terminal side of the one conducting path 22 during the routing. In addition, the second cut conducting path 25 is used as vibration absorbing means that absorbs the vibration during driving of a car after the routing. The inter-conducting path connecting portion 26 is applied as a connecting site for using the second cut conducting path 25 as the above-described means at a predetermined position of the one conducting path 22. It is needless to say that the application of the inter-conducting path connecting portion 26 secures the insulation properties, the waterproof properties, and the shielding properties in the connecting site.

Here, in FIGS. 11B and 11C, the first elongated cut conducting path 24a and 24b, the second cut conducting path 25 connecting the two cut conducting paths, and the two inter-conducting path connecting portions 26 are illustrated. The first elongated cut conducting paths 24a and 24b are routed along the vehicle underside 11. In FIG. 11B, for example, the second cut conducting path 25 is used as dimension error absorbing means for absorbing a dimension error in a case where the dimension error occurs during the routing. Here, the dimension error is absorbed by shrinkage of the second cut conducting paths 25. In FIG. 11C, the second cut conducting path 25 is used as vibration absorbing means for absorbing the vibration during driving of a car after the routing. In addition, in a case where the second cut conducting path 25 is used as the resonance avoiding means for avoiding the resonance after the routing. The inter-conducting path connecting portion 26 is applied as the connecting site for using the second cut conducting path 25 as the above-described means at a predetermined position of the one conducting path 22. It is necessary to say that the application of the inter-conducting path connecting portion 26 secures the insulation properties, the waterproof properties, and the shielding properties in the connecting site.

In FIG. 12A, the first cut conducting path 24a and 24b, the second cut conducting path 25 connecting the two cut conducting paths, and the two inter-conducting path connecting portions 26 are illustrated. The first cut conducting paths 24a and 24b remain in a straight state. In other words, the conducting paths are in a state in which the bending is not performed. On the other hand, the second cut conducting path 25 is flexible, and thus the second cut conducting path 25 is used as folding means for achieving compactness during packaging or transporting before the routing. Here, the second cut conducting path 25 is subjected to bending such as folding, and thereby it is possible to realize the compactness. The second cut conducting path 25 returns to an original state (state before packaging) from the folded state before the routing in the hybrid car 1.

Here, in FIG. 12B, the first cut conducting path 24a and 24b, the second cut conducting path 25 connecting the two cut conducting paths, and the two inter-conducting path connecting portions 26 are illustrated. The first cut conducting paths 24a and 24b are routed in a plane along the vehicle underside 11. The second cut conducting path 25 is used as bending means for changing a path of the one conducting path 22 during the routing. In the figure, the second cut conducting path 25 is subjected to crank-shaped bending; however, the bending shape or the bending direction is only an example.

In FIGS. 12A to 12B, it is needless to say that the application of the inter-conducting path connecting portion 26 secures the insulation properties, the waterproof properties, and the shielding properties in the connecting site.

### <Regarding Effect of Present Invention>

As described above with reference to FIGS. 1 to 12, according to the inter-conducting path connecting portion 26 of the invention, the inter-connecting end connecting portion 41 is formed by connecting the connecting ends 28 and 35 of the one or the other of the first cut conducting path 24 and the second cut conducting path 25, and the insulating waterproof treatment portion 42 including the conductor exposed portions 33 and 40 on the periphery of the inter-connecting end connecting portion 41 directly comes into the insulation state and the waterproof state. Therefore, it is possible to secure the insulation properties and the waterproof properties in the site In addition, according to the inter-conducting path connecting portion 26 of the invention, since the entire insulating waterproof treatment portion 42 is covered with the shield processing part 43, it is possible to secure the shielding properties. Hence, according to the inter-conducting path connecting portion 26 of the invention, the effect of making it possible to secure the insulation properties, the waterproof properties, and the shielding properties in the connecting site between the conducting paths is achieved.

In addition, according to wire harness 9 of the present invention, since one single conducting path 22 of the one or the plurality of conducting paths is configured to include the inter-conducting path connecting portion 26, the effect of making it possible to secure the insulation properties, the waterproof properties, and the shielding properties in the connecting site between the first cut conducting path 24 and the second cut conducting path 25 adjacent to each other or an effect of making it possible to exhibit the shape retention function of matching the shape of the routing target position is achieved.

In addition, according to the wire harness 9 of the present invention, the inter-conducting path connecting portion 26 is included, and thus an effect of making it possible to reduce the number of components causing path restriction, to reduce weight, or to reduce total costs, compared to the related art, is achieved. The effect is easily understood when the following content is considered.

According to the present invention, the wire harness 9 includes the first cut conducting paths 24, which includes the one conducting path 22 and in which the one conducting path 22 is divided into a plurality of conducting paths, the second cut conducting path 25 that connects the adjacent first cut conducting paths 24 for one conducting path 22, and the second cut conducting path 25 is formed to have the lower stiffness than that of the first cut conducting path 24 so as to be shrinkable and bendable in a predetermined direction. Therefore, when the disposition of the second cut conducting path 25 is adjusted, it is possible to use the second cut conducting path 25 as a site that contributes to improvement in the workability or the like. In other words, when the wire harness 9 includes a plurality of conducting paths 22, an effect of achieving the improvement in the workability or the like is achieved.

In addition, according to the wire harness 9, the second cut conducting path 25 is formed to be shorter than the first cut conducting paths 24, and thus a percentage of the second cut conducting path 25 in the one conducting path 22 is small. As a result, an effect of making it possible to provide the better wire harness 9 without causing damage to the function of maintaining the shape of the routing path is achieved.

In addition, according to the wire harness 9, the second cut conducting path 25 is formed to be bendable in two directions or a 360-degree direction, and thus an effect of making it possible to achieve the improvement in the workability or the like due to the bending is achieved.

In addition, according to the wire harness 9, at least one second cut conducting path 25 is disposed in a range in which the wire harness 9 is routed along the vehicle underside 11, and thus it is possible to use various types of means to be described below even in a region in which the routing is elongated. Hence, an effect of making it possible to provide the wire harness 9 is achieved.

In addition, according to the wire harness 9, the second cut conducting path 25 is applied as the bending means, the folding means, the dimension error absorbing means, the resonance avoiding means, the vibration absorbing means, or the like, and thus effects of achieving the compactness during packaging and transporting of the wire harness 9, making it easy to perform bending and absorb the dimension error during the routing, and further making it possible to avoid a problem or the like due to the resonance an to absorb the vibration after the routing are achieved.

The wire harness 9 of Example 1 may be configured such as following (1) to (8).

(1) In the wire harness that is configured to include one or the plurality of conducting paths and is routed in a car so as to perform the electrical connection, the one conducting path is configured to include a plurality of first cut conducting paths including terminals of the one conducting path, one or a plurality of second cut conducting paths having conductivity which are disposed between the first cut conducting paths and connects the first cut conducting paths, an a plurality of inter-conducting path connecting portions as connecting sites between the first cut conducting paths and the second cut conducting paths, the first cut conducting path and the second cut conducting path are each configured to include a main body portion having the conductor and the insulator, and connecting ends which is positioned at both ends of the main body portion and at which the conductor is exposed, and the main body portion of the second cut conducting path is formed to have lower stiffness than that of the first cut conducting path and is shrinkable and bendable in a predetermined direction, and the inter-conducting path connecting portion is configured to include the inter-connecting end connecting portion in which connecting ends of the first cut conducting path and the second cut conducting path are connected to each other, the conductor exposed portion in which the outer circumferences of the conductors are exposed on both sides of the inter-connecting end connecting portion, the insulating waterproof treatment portion for performing the treatment directly on the conductor exposed portion such that the conductor exposed portion comes into an insulating state and a waterproof state, the shield processing part that covers the entire insulating waterproof treatment portion.

(2) In the wire harness according to (1) above, the second cut conducting path is formed to be shorter than the first cut conducting path.

(3) In the wire harness according to (1) or (2) above, the predetermined direction of the second cut conducting path is two directions or in a 360-degree direction.

(4) In the wire harness according to (1), (2), or (3) above, at least one second cut conducting path is formed to be disposed in a range in which the wire harness is routed along a body of the car.

(5) In the wire harness according to (1), (2), (3), or (4) above, the second cut conducting path is applied as at least one of folding means for the compactness during the packaging before the routing in the car, the dimension error absorbing means for absorbing the dimension error during the routing, and the resonance avoiding means for avoiding resonance after the routing.

(6) In the wire harness according to (1), (2), (3), (4) or (5) above, the first cut conducting path is configured to include the conductor made of aluminum or an aluminum alloy and the insulator that covers the conductor, in which the shape thereof is retained during the routing due to the stiffness of the conductor.

(7) In the wire harness according to (1), (2), (3), (4), (5), or (6) above, the main body portion of the second cut conducting path is configured to include the conductor that is flexible and is made of aluminum or an aluminum alloy and the insulator having insulation properties which covers the conductor.

(8) The wire harness according to (1), (2), (3), (4), (5), (6), or (7) above, further is configured to further include the resin exterior member that accommodates and protects the second cut conducting path.”

### EXAMPLE 2

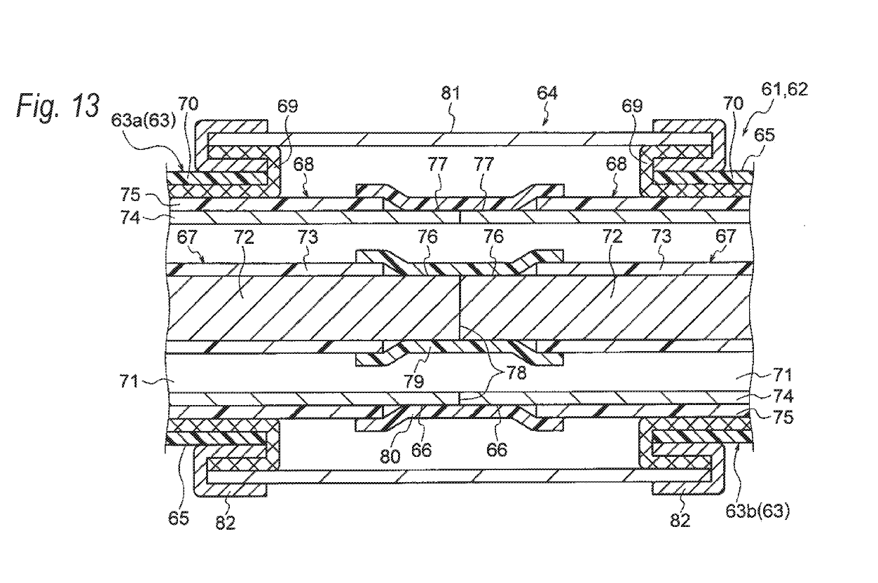

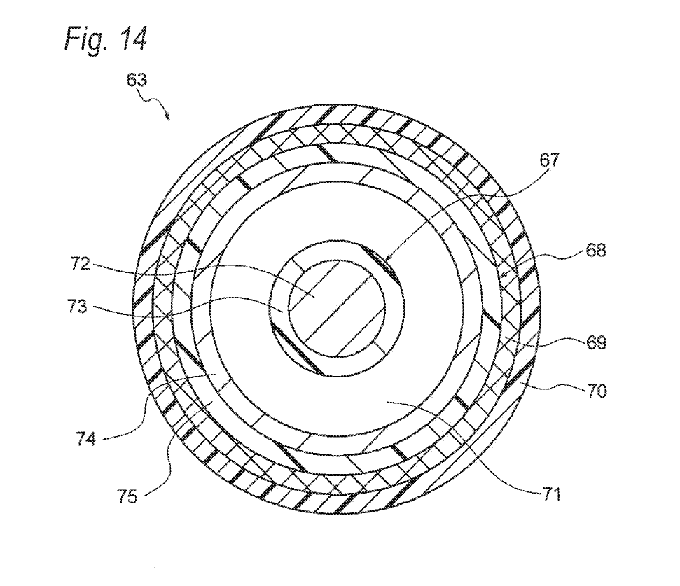

Hereinafter, Example 2 will be described with reference to figures. FIG. 13 is a configurational view illustrating the inter-conducting path connecting portion as another example. In addition, FIG. 14 is a cross-sectional view of the conducting path in FIG. 13.

### <Regarding Harness Main Body 61 and Conducting Path 62>

In FIG. 13, the harness main body 61 includes the one conducting path 62, and the conducting path 62 is configured to have the cut conducting paths 63 (63a, 63b, . . . ) which are divided into a plurality of paths, the inter-conducting path connecting portion 64 of the present invention which is formed as the direct connecting site between the cut conducting paths 63 adjacent to each other, and the terminal metal fittings (not illustrated) provided at terminals of the one conducting path 62. The conducting path 62 is an elongated one although not clearly shown in FIG. 13.

### <Regarding Cut Conducting Path 63>

In FIGS. 13 to 14, the cut conducting path 63 is configured to include a main body portion 65 and connecting ends 66 positioned at both ends of the main body portion 65.

The main body portion 65 is configured to include a first circuit 67 having conductivity, an second circuit 68 that is coaxial to the first circuit 67 on the outer side thereof, a conductive shielding member 69 that is provided on the outer side of the second circuit 68, and an insulating sheath 70 with which the shielding member 69 is coated. Reference numeral 71 represents an internal space, and a configuration in which another first circuit 67 is disposed in the internal space 71 may be employed. The first circuit 67 is configured to include a conductive rod conductor 72 and an insulator 73 having insulation properties with which the rod conductor 72 is coated. The first circuit 67 is formed to be in an electric wire state. On the other hand, the second circuit 68 is configured to include a tubular conductor 74 having the conductivity and stiffness and an insulator 75 having insulation properties with which the tubular conductor 74 is coated.

The connecting ends 66 are formed as connecting sites of the adjacent cut conducting paths 63. The connecting end 66 is formed by removing the insulators 73 and 75 and the sheath 70 from the terminal of the main body portion 65 and exposing the rod conductor 72 and the tubular conductor 74. Reference numerals 76 and 77 represents conductor exposed portions that are exposed as outer circumferences of the rod conductor 72 and the tubular conductor 74 (connecting end 66).

### <Regarding Inter-Conducting Path Connecting Portion 64>

In FIG. 13, the inter-conducting path connecting portion 64 is formed as the connecting site in which an inter-connecting end connecting portion 78 between the adjacent cut conducting paths 63 is formed. In addition, the inter-conducting path connecting portion 64 is also formed as a site in which the insulation properties, the waterproof properties, and the shielding properties are secured in the connecting site. The inter-conducting path connecting portion 64 is configured to include the inter-connecting end connecting portion 78, the conductor exposed portions 76 and 77 of the adjacent cut conducting paths 63, an insulating waterproof treatment portion 79 for the first circuit 67, an insulating waterproof treatment portion 80 for the second circuit 68, a shield processing part 81, and two shield connecting parts 82. An effect of the inter-conducting path connecting portion 64 is the same as that in Example 1.

In addition, it is needless to say that the present invention can be modified in various manners in a range without changing the gist of the present invention.

The present invention according to a first aspect made in order to achieve the object described above provides a structure of an inter-conducting path connecting portion (26) which is a connecting site of one and the other cut conducting paths which are in a cut state and in an adjacent state, the structure including:

an inter-connecting end connecting portion (41) in which connecting ends of conductors of the one and the other cut conducting paths (24, 25) are connected to each other;

a conductor exposed portion (33, 40) in which outer circumferences of the conductors are exposed on both sides of the inter-connecting end connecting portion (41);

an insulating waterproof treatment portion (42) for performing treatment directly on the conductor exposed portion (33, 40) such that the conductor exposed portion (33, 40) comes into an insulating state and a waterproof state; and

a shield processing part (43) that covers the entire insulating waterproof treatment portion (42).

The present invention according to a second aspect provides the structure of an inter-conducting path connecting portion according to the first aspect further including:

a shield connecting part (44) for connecting end portions of shielding members (31,38) that configure the one and the other cut conducting paths (24, 25) and end portions of the shield processing part (43) to each other.

The present invention according to a third aspect provides the structure of an inter-conducting path connecting portion according to the first or second aspect, wherein the one cut conducting path (24) has a stiffness so as to ensure shape retention performance, and the other cut conducting path (25) has lower shape retention performance than that of the one cut conducting path (24) and has flexibility.

In addition, the present invention according to a fourth aspect made in order to achieve the object described above provides a wire harness (15) configured to be routed in a car so as to perform electrical connection, the wire harness (15) includes one or a plurality of conducting paths (22), in which one of the conducting path includes a plurality of cut conducting paths (24, 25) which are in a cut state and an inter-conducting path connecting portion (26) that is a connecting site of the one and the other cut conducting paths (24, 25) adjacent to each other and has the structure according to the first, second, or third aspect.

In the present invention according to the first aspect, the inter-connecting end connecting portion is formed by connecting the conductors of the one or the other cut conducting paths, and the insulating waterproof treatment portion including the conductor exposed portion on the periphery of the inter-connecting end connecting portion directly comes into the insulation state and the waterproof state. Therefore, it is possible to secure the insulation properties and the waterproof properties in the site. In addition, according to the present invention, since the entire insulating waterproof treatment portion is covered with the shield processing part, it is possible to secure the shielding properties. Hence, according to the present invention, an effect of making it possible to secure the insulation properties, the waterproof properties, and the shielding properties in the connecting site between the conducting paths is achieved.

In the present invention according to the second aspect, the following effect is further achieved in addition to the effect of the first aspect. In other words, since the shield connecting part is provided, it is possible to connect the end portions of the shielding members to the shield processing part without performing specific processing on the end portions of the shielding members in the one and the other cut conducting paths. As a result, an effect of making it possible to contribute to securing the shielding properties is achieved.

In the present invention according to the third aspect, the following effect is further achieved in addition to the effect of the first or second aspect. In other words, an effect of making it possible to exhibit the shape retention function of matching a shape of a routing target position is achieved.

In the present invention according to the fourth aspect, since one single conducting path of the one or the plurality of conducting paths is configured to include the inter-conducting path connecting portion that is formed by employing the structure according to the first, second, or third aspect, an effect of making it possible to secure the insulation properties, the waterproof properties, and the shielding properties in the connecting site between the one and the other cut conducting paths adjacent to each other is achieved. In addition, an effect of making it possible to exhibit the shape retention function of matching a shape of a routing target position is also achieved.

What is claimed is:

1. A structure of an inter-conducting path connecting portion which is a connecting site of one and the other cut conducting paths which are in a cut state and in an adjacent state, the structure comprising:
an inter-connecting end connecting portion in which connecting ends of conductors of the one and the other cut conducting paths are connected to each other;
a conductor exposed portion in which outer circumferences of the conductors are exposed on both sides of the inter-connecting end connecting portion;
an insulating waterproof treatment portion for performing treatment directly on the conductor exposed portion such that the conductor exposed portion comes into an insulating state and a waterproof state; and
a shield processing part that covers the entire insulating waterproof treatment portion.

2. The structure of an inter-conducting path connecting portion according to claim 1, further comprising
a shield connecting part for connecting end portions of shielding members that configure the one and the other cut conducting paths and end portions of the shield processing part to each other.

3. The structure of an inter-conducting path connecting portion according to claim 1, wherein
the one cut conducting path has a stiffness so as to ensure shape retention performance, and
the other cut conducting path has lower shape retention performance than that of the one cut conducting path and has flexibility.

4. A wire harness, configured to be routed in a car so as to perform electrical connection, the wire harness comprising:
one or a plurality of conducting paths,
wherein one of the conducting paths includes a plurality of cut conducting paths which are in a cut state and an inter-conducting path connecting portion that is a connecting site of the one and the other cut conducting paths adjacent to each other, and has the structure according to claim 1.
